(19) United States
(12) Patent Application Publication
(10) Pub. No.: US 2006/0205909 A1
(43) Pub. Date: Sep. 14, 2006

(54) Polyester polyols for polyurethane adhesives

(76) Inventor: Michael E. O'Brien, Hainesville, IL (US)

Correspondence Address: MCANDREWS HELD & MALLOY, LTD, 500 WEST MADISON STREET, SUITE 3400, CHICAGO, IL, 60661, US

(21) Appl. No.: 10/546,496

(22) PCT Filed: Mar. 12, 2004
(86) PCT No.: PCT/US04/07807

§ 371 Date: Apr. 5, 2006

Related U.S. Application Data
(60) Provisional application No. 60/454,222, filed on Mar. 13, 2003.

(51) Int. Cl. C08G 18/00

(52) U.S. Cl. 528/44

(57) ABSTRACT

A polyester polyol prepared from a composition including a phthalic acid based material containing more than 10% by weight of ortho-phahalic or derivatives thereof, an aliphatic dicarboxylic acid (e.g., dodecanedioic acid), and a polyol (e.g., a glycol). A polyurethane adhesive, such as a polyurethane reactive hot-melt adhesive, is made using the polyester polyol, which exhibits improved initial bonding strength, shortened setting time, and ability to bond to low surface energy substrates such as ABS. The methods to prepare the polyester polyol and the polyurethane adhesive, and the method to use them are also disclosed.

### RELATED APPLICATIONS

This application is a non-provisional utility patent application claiming priority to U.S. provisional patent application Ser. No. 60/454,222, filed Mar. 13, 2003, now pending. The entire specification and all the claims of the provisional application referred to above are hereby incorporated by reference to provide continuity of disclosure.

### FIELD OF THE INVENTION

The presently described technology relates to polyester polyols derived from phthalic acid based materials, such as phthalic anhydride, and their use in preparing polyurethane adhesives, particularly polyurethane hot-melt adhesives.

### BACKGROUND OF THE INVENTION

A moisture-curing polyurethane hot-melt adhesive (i.e., a polyurethane reactive hot-melt adhesive; or PUR hot-melt adhesive) is understood to be an adhesive largely free of solvents and having urethane groups, which is solid at room temperature and following application in the form of its melt physically binds not only by cooling, but also by chemical reaction of still present isocyanate groups with moisture in the air. Upon curing, the molecule size increases and the adhesive attains its final characteristics.

PUR hot-melt adhesives are generally produced from moisture-curing polyurethane prepolymers. They are made by reacting an excess amount of isocyanate with a polyol or a mixture of polyols. The resulting polymer's end groups are isocyanates (—NCO) that will react with moisture in the air or substrate to cure the adhesive system. Typically, a PUR hot-melt adhesive is initially meltable, like the conventional hot-melt adhesives, and sets in accordance with the typical hot/cold mechanism. After the initial setting, these adhesives undergo irreversible crosslinking in the bonded joint within a period of a few days, as a result of chemical reaction of remaining isocyanate (—NCO) groups with moisture. During this process, the originally thermoplastic film undergoes a transition to a thermoset state. In other words, the formerly thermoplastic hot-melt adhesive joint is now crosslinked and can no longer be melted. From the time of application until crosslinking, there is a time period where the initial adhesion strength, i.e., the strength of the bonded materials directly after bonding, is relatively low. The length of this time period depends on the chemical composition of the adhesive and can range from several hours to several days.

In many applications, rapid setting of the hot-melt adhesive is necessary in order to further process the bonded articles and still maintain a short pot life. Accordingly, there have been many attempts to produce moisture-crosslinking PUR hot-melt adhesives that have improved initial bonding strength and a shorter setting time.

A variety of PUR hot-melt adhesive composition are known, along with a variety of processes to prepare such materials. “Moisture-Curing Reactive Polyurethane Hot-melt Adhesives,” Paul Waites, Pigm. Resin Technology; vol. 26, No. 5, 1997, pp. 300-03, provides a summary of PUR hot-melt technology and what these types of adhesives bond to for final application. “Shaping Reactive Hot-melts Using LMW Copolyesters,” Huber, et. al., Adhesives Age, November 1987, pp. 32-35, summarizes the characteristics of various polyester derived PUR hot-melt adhesives. Many PUR hot-melt adhesives and the associated processes have various undesirable compositional, adhesive and/or processing limitations.

Therefore, different measures have been undertaken to produce moisture-curable hot-melt adhesives with high initial bonding strength including, for example, (1) addition of a tackifying resin, (2) addition of a thermoplastic resin, (3) combination of different polyurethane prepolymers (or polyols) and (4) utilizing a polyurethane prepolymer with a specific structure. But many moisture-curable hot-melt adhesives still have the drawback of low initial cohesion of the adhesives even though some degree of initial adhesion is achieved.

Additionally, although suitable for many applications, PUR hot-melt adhesives have demonstrated limited ability to bond to certain low surface energy substrates, in particular, difficult-to-bond acrylonitrile-butadiene-styrene (“ABS”) polymers. ABS polymers are elastomeric and thermoplastic composites that exhibit excellent toughness. This property allows ABS to be used in a variety of applications, most importantly in plastic parts for automobiles, making it one of the largest selling thermoplastics today. A more complete description of the properties of ABS may be found in the Encyclopedia of Polymer Science and Engineering, vol. 1:388-426 (Wiley, 1985). However, many ABS substrates present a challenge for bonding with polyurethane hot-melt adhesives. Without being bound by any particular theory, it is believed that the low surface energy of many ABS materials renders them extremely difficult to bond with conventional polyurethane hot-melt adhesives. Another possibility is that oil, mold release agent, and other low molecular weight contaminants which may be used in the production process of ABS contribute to the difficulty of bonding ABS with polyurethane hot-melt adhesives. Therefore, a moisture curable polyurethane hot-melt adhesive that bonds to low surface energy substrates such as difficult-to-bond ABS, polyethylene, polypropylene, aluminum, and steel, as well as other substrates such as fiber-reinforced plastic, plywood, paper board, and the like, is highly desired.

For example, U.S. Pat. No. 6,221,978 (Li et al., the “'978 patent”) describes a moisture curable polyurethane reactive hot-melt adhesive made with an epoxy resin and a polyurethane prepolymer that is “substantially free” of ortho-phthalic acid based polyester polyols and can bond to low energy surfaces such as ABS. The '978 patent specifically requires that the polyester polyol component of the polyurethane adhesive is derived from a composition substantially free of “phthalic acid or derivatives thereof, wherein said derivatives are selected from the group consisting of anhydrides, halides, and alkyl esters.”

For reasons stated above, polyurethane adhesive customers are constantly looking for products that will enhance their bonding performance to different substrates, especially to those difficult-to-bond substrates, and exhibit improved initial bonding strength and a shortened setting time.

### BRIEF SUMMARY OF THE INVENTION

It has been discovered that a new series of polyester polyols derived from phthalic acid-based materials have shown unexpected results when incorporated in a polyurethane reactive (sometimes referred to as “PUR” in this disclosure) hot-melt adhesive application. More particularly, the presently described technology relates to a polyester polyol prepared from a composition including a phthalic acid based material containing more than about 10% by weight of ortho-phthalic acid or derivatives thereof, based on the total weight of the phthalic acid based material, an aliphatic dicarboxylic acid or derivatives thereof, and a polyol (e.g., a glycol). The polyester polyol of the presently described technology (sometimes referred to as “PDG polyol” in this specification) can be used to prepare polyurethane adhesives. One key advantage of using the PDG polyol of the presently described technology has been the bonding profile seen when this product is used in an adhesive application. It has surprisingly been discovered that moisture curable polyurethane hot-melt adhesives (i.e., polyurethane reactive hot-melt adhesives; commonly termed as “PUR hot-melt adhesives”) derived from the unique polyester polyols of the presently described technology bond well to a wide variety of substrate materials. Representative materials include fiber-reinforced plastic, plywood, paperboard, and the like. The PUR hot-melt adhesives of the presently described technology demonstrate excellent adhesion even to low surface energy substrates such as difficult-to-bond ABS, and exhibit improved initial bonding strength and shortened setting time as well.

In one aspect, the presently described technology provides a polyester polyol prepared from a reaction mixture having: a phthalic acid based material containing more than about 10% by weight, based on the total weight of the phthalic acid based material, of ortho-phthalic acid, a derivative of ortho-phthalic acid or a mixture thereof; at least one aliphatic dicarboxylic acid or a derivative thereof having a straight or branched carbon chain that has about four or more carbon atoms, and preferably has from about four to about twenty carbon atoms; and at least one polyol. The polyester polyol of the presently described technology typically has an average hydroxyl value of from about 5 to about 405, preferably from about 15 to about 150, more preferably from about 20 to about 35. Examples of phthalic acid based materials are phthalic anhydride or ortho-phthalic acid; and the preferred aliphatic dicarboxylic acid is dodecanedioic acid. Any polyol can be used to make the polyester polyol of the presently described technology. For example, such a polyol can have the following formula:
HO—R₁—OH
wherein R₁ represents:
(1) alkylene groups of from about 2 to about 12 carbon atoms;
(2) —CH₂—R₂—CH₂— where R₂ represents: 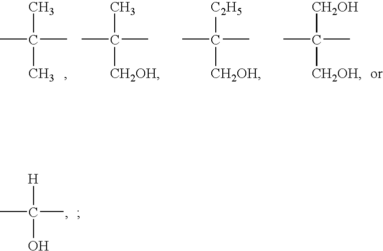
   or
(3) —(R₃O)ₙ—R₃— where each R₃ independently represents an alkylene group of from about 2 to about 4 carbon atoms, and n is an integer of from about 1 to about 200.

In one embodiment, the polyester polyol of the presently described technology is prepared from a reaction mixture that includes, based on the total weight of the following three components: (a) from about 0.2% to about 70% by weight of phthalic anhydride, ortho-phthalic acid or a combination thereof; (b) from about 0.1% to about 78% by weight of at least one C₄-C₂₀ aliphatic dioic acid, a derivative thereof or a mixture thereof; and (c) from about 20% to about 87% by weight of at least one polyol having the above fonnula, HO—R₁—OH.

In another aspect, the presently described technology provides a polyurethane adhesive composition having an unreacted isocyanate value of from about 0.5% to about 20%, preferably from about 0.8% to about 5%, which is obtained from a reaction mixture including:
(I) from about 15% to about 99% by weight, based on the total weight of components (I) and (II), a polyester polyol which is the product of a reaction mixture having:
   (a) a phthalic acid based material containing more than about 10% by weight of ortho-phthalic acid, a derivative of ortho-phthalic acid or a mixture thereof, based on the total weight of the phthalic acid based material;
   (b) at least one aliphatic dicarboxylic acid or a derivative thereof having a straight or branched carbon chain that has four or more carbon atoms; and
   (c) at least one polyol; and
   wherein the polyester polyol has an average hydroxyl value of from about 5 to about 405; and
(II) at least one aliphatic or aromatic diisocyanate in an amount sufficient to produce the polyurethane adhesive composition having the unreacted isocyanate value of from about 0.5% to about 20%.

In one embodiment, the polyurethane adhesive composition of the present technology can further include a secondary polyester polyol. Examples of suitable secondary polyester polyols can include, but are not limited to, 1,6-hexanediol adipate and a phthalate-diethylene glycol based polyester polyol.

Methods for preparing the polyester polyols and polyurethane adhesive compositions of the presently described technology are also disclosed. A method to bond a first substrate to a second substrate by applying to at least one of the substrates a polyurethane adhesive composition of the present technology is also within the scope of the presently described technology.

These and other aspects and advantages are achieved by the detailed invention description below.

### BRIEF DESCRIPTION OF SEVERAL VIEWS OF THE DRAWINGS

[Not Applicable]

### DETAILED DESCRIPTION OF THE INVENTION

The term “functionality” as used herein means the number of reactive groups, e.g., hydroxyl groups, in a molecule.

The term “hydroxyl value” or “OH value” or “OHV” as used herein refers to a quantitative measure of the concentration of hydroxyl groups, usually stated as mg KOH/g, i.e., the number of milligrams of potassium hydroxide equivalent to the hydroxyl groups in 1 g of substance.

The phrase “low surface energy” as utilized herein shall be understood to mean a substrate possessing a surface energy of less than 38 dyne as determined using ACCUDYNE® test marker pens from Diversified Enterprises, Claremont, N.H.

The term “phthalic acid based material” as used herein means materials containing phthalic acid or phthalic anhydride, or derivatives thereof, or the like. Examples of phthalic acid based materials include, but are not limited to, ortho-phthalic acid; isophthalic acid; terephthalic acid; alkyl esters or halides of ortho-phthalic, isophthalic, or terephthalic acid; phthalic anhydride; dimethyl terephthalate; polyethylene terephthalate; trimellitic anhydride; pyromellitic dianhydride; and mixtures thereof.

The term “polyester polyol” as used herein means a polyol having ester linkages.

While the presently described technology will be described in connection with one or more preferred embodiments, it will be understood by those skilled in the art that the technology is not limited to only those particular embodiments. To the contrary, the presently described technology includes all alternatives, modifications, and equivalents as may be included within the spirit and scope of the appended claims.

The presently described technology encompasses a polyester polyol (sometimes referred to as a “PDG polyol” in this disclosure) that is made by reacting a mixture including a phthalic acid based material containing more than about 10 wt % ortho-phthalic acid and/or a derivative thereof, an aliphatic dicarboxylic acid, and a polyol. The PDG polyols of the present technology incorporate the aliphatic dicarboxylic acid into the backbones of the polyol molecules, and can be used in polyurethane coatings, adhesives, sealants and elastomers. The polyurethane adhesives made from these polyols have a broad bonding profile that allows them to bond to a wide variety of substrates. These adhesives can be used for general bonding in areas such as general-purpose construction, automotive, fabric and other adhesive applications. The PDG polyols of the presently described technology can also be used in coating formulations such as polyurethane dispersions (sometimes referred to as “PUD” in this disclosure). The PUDs made from the PDG polyol can be used to coat metal, wood and plastics, and be used as water based adhesives to bond a variety of products including wood-to-wood and plastic to wood. The PDG polyols can also be used in other coating applications such as top coating, radiation cured and solvent based coatings.

Methods to produce the PDG polyols and polyurethane adhesives and the method to use the polyurethane adhesives to bond substrates are also encompassed by the presently described technology.

### I. PDG POLYOL COMPONENT

1. Phthalic Acid Based Material

Phthalic acid based materials that may be used in preparing the aromatic polyester polyols of the presently described technology can be, for example: (a) substantially pure phthalic acid or phthalic acid derivatives including ortho-phthalic acid, phthalic anhydride, terephthalic acid, dimethyl terephthalate, isophthalic acid, trimellitic anhydride, pyromellitic dianhydride, or mixtures thereof; or (b) mixtures such as side stream, waste or scrap products containing residues of phthalic acid or phthalic acid derivatives. In this context, “residues of phthalic acid” means any reacted or unreacted phthalic acid remaining in a product after its manufacture by a process in which phthalic acid or a derivative thereof is a starting component or final product. These mixtures are generally available from the manufacture of phthalic acid, terephthalic acid, dimethyl terephthalate, polyethylene terephthalate, and the like.

To further illustrates, residues of phthalic acid means the group: 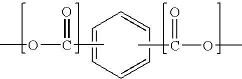
Mixtures containing residues of phthalic acid that may be used in the presently described technology include, but are not limited to: (a) ester-containing by-products from the manufacture of dimethyl terephthalate; (b) scrap polyalkylene terephthalates; (c) residues from the manufacture of phthalic acid or phthalic anhydride; (d) residues from the manufacture of terephthalic acid; and (e) combinations thereof.

These pure materials or mixtures can be conveniently converted to an aromatic polyester polyol by reaction with hydroxylated materials, such as glycols. Alternatively, these pure materials and mixtures may be converted to aromatic polyester polyols by reaction with intermediate polyols of the phthalic acid based material/hydroxylated material reaction product type through conventional transesterification or esterification procedures.

The phthalic acid based materials used in the presently described technology typically shall contain more than about 10% by weight, based on the total weight of the phthalic acid based material, of ortho-phthalic acid, a derivative thereof or a mixture thereof, which can be ortho-phthalic acid residues.

2. Aliphatic Dicarboxylic Acid

Suitable aliphatic dicarboxylic acids are straight or branched diacids or mixtures of such diacids having from about 4 to about 50, preferably from about 4 to about 20, carbon atoms, including the atoms contained in the carboxy groups. Derivatives of these aliphatic dicarboxylic acids, such as anhydrides, halides or alkyl esters of diacids, and the like, can also be used in the presently described technology. More preferred aliphatic dicarboxylic acids are diacids having from about 6 to about 18 carbon atoms; even more preferred are those having from about 10 to about 14 carbon atoms, and derivatives of such diacids, and the like. Straight chain diacids and their derivatives are preferred. Examples of aliphatic dicarboxylic acids include, but are not limited to, dodecanedioic acid, succinic acid, glutaric acid, adipic acid, azelaic acid, sebacic acid, decanedicarboxylic acid, octadecanedicarboxylic acid, 1,4-cyclohexanedicarboxylic acid, dimerized fatty acids, fumaric acid, derivatives thereof, and the like. The particularly preferred diacid is a straight chain C₁₂ diacid, dodecanedioic acid (“DDDA”) or a derivative thereof.

3. Polyol Component

Any polyol can be used in the presently described technology. Numerous suitable polyols for use in making the polyester polyol are known to those skilled in the art and will be readily apparent in view of the present disclosure. Included are many commercially available polyols and others which are readily prepared according to known methods. The typical polyols suitable to make the PDG polyol of the presently described technology can be represented by the following formula:
HO—R₁—OH
where R₁ in the formula represents:
(1) alkylene groups of from about 2 to about 12 carbon atoms;
(2) —CH₂—R₂—CH₂— where R₂ represents: 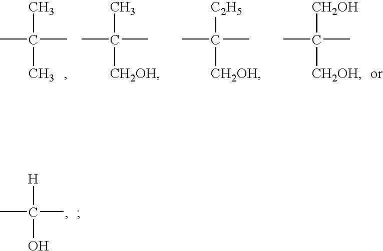
   or
(3) —(R₃O)ₙ—R₃— where each R₃ independently represents an alkylene group of from about 2 to about 4 carbon atoms, and n is an integer of from about 1 to about 200.

Examples of suitable polyols represented by the above formula include, but are not limited to, ethylene glycol, diethylene glycol, triethylene glycol, propylene glycol, dipropylene glycol, trimethylene glycol, butylene glycols, neopentyl glycol, 1,2-cyclohexanediol, poly(oxyalkylene)polyols derived by the condensation of ethylene oxide, propylene oxide or any combination thereof, glycerol, 1,1,1-trimethylolpropane, 1,1,1-trimethylolethane, 2,2-dimethyl-1,3-propane diol, pentaerythritol, and combinations thereof. Preferred polyols are 1,6-hexanediol (sometimes referred to as “HDO” in this disclosure), diethylene glycol (sometimes referred to as “DEG” in this disclosure), neopentyl glycol (sometimes referred to as “NPG” in this disclosure), glycerine, trimethyolpropane, pentaerythritol, and combinations thereof. The particularly preferred polyol is 1,6-hexanediol.

### II. PDG POLYOL SYNTHESIS

Synthesis of the PDG polyols of the presently described technology is relatively straightforward, as representatively shown below in Scheme I; this scheme exemplifies the production of a dodecanedioic acid derived PDG polyol, i.e., PA-DDDA polyol. Multiple polyols can be used, such as 1,6-hexanediol, diethylene glycol, neopentyl glycol, glycerine, or pentaerythritol for example. Mixtures of such or other polyols may be utilized as well. Glycols (i.e., diols) are preferred, and the most preferred diol is 1,6-hexanediol. The diacid materials may vary in length from about C₄ to about C₅₀. Dodecanedioic acid is the preferred diacid.

Small amounts of esterification catalyst can be employed in the synthesis to promote reaction. Suitable esterification catalysts are well known to those of ordinary skill and speed the in the art. Generally, any suitable esterification catalyst may be utilized in the present technology, provided that it does not interfere with the formation of the desired PDG polyol, the formation of the PUR hot-melt adhesive or the performance of such adhesive. Tin catalysts or titanium catalysts are preferred.

Typically, the esterification catalyst is present from about 0.001 to about 0.1 percent by weight, based on the total weight of the three components discussed above for PDG polyols. Examples of suitable catalysts include, but are not limited to, acids such as sulfuric acid, phosphoric acid, para-toluene sulfonic acid, organotin compounds such dibutyl tin-(IV) dilaurate, and titanium compounds such as titanium (IV) isoproproxide, hydrated monobutyltin oxide, dibutyltin oxide, or titanium (IV) butoxide (titanium tetrabutoxide, TBT). Preferably, the reaction mixture comprises from about 25 to about 800 ppm of the esterification catalyst.

Optionally, a glycidyl ester such as CARDURA® E-10P (CAS Registry No. 26761-45-5, available from Resolution Performance Products LLC, Houston, Tex.) can be added to help reduce the acid value of the polyol.

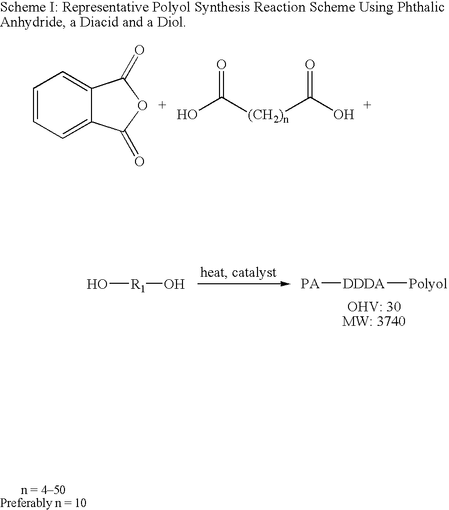

Scheme I outlines a representative synthetic route for a polyester polyol of the presently described technology, wherein the phthalic acid based material is phthalic anhydride. A preferred PDG polyol as shown in Scheme I is a PA-DDDA type polyester polyol, which can be prepared from a reaction mixture of phthalic anhydride, dodecanedioic acid, and 1,6-hexanediol. A tin catalyst (e.g., hydrated monobutyl tin oxide available from Atofina Chemicals, Inc., Philadelphia, Pa., commercially available under the trade name FASCAT® 9100) can be used as the esterification catalyst. Preferably, the reaction mixture can be heated to from about 200° C. to about 225° C. under an inert gas atmosphere, for example nitrogen (N₂) or argon (Ar).

The average hydroxyl value (“OHV”) of the PDG polyols of the presently described technology can range from about 5 to about 405, preferably from about 15 to about 150, and more preferably from about 20 to about 35. The average molecular weight of the PDG polyol will depend on the functionality of the PDG polyol, and can be calculated from the average hydroxyl value of the PDG polyol. For example, the average molecular weight of the PDG polyols of the presently described technology may range from about 277 g/mol (405 OHV) to about 22,440 g/mol (5 OHV), preferably from about 748 g/mol (150 OHV) to about 7480 g/mol (15 OHV); more preferably from about 3200 g/mol (35 OHV) to about 5600 g/mol (20 OHV), and most preferably from about 3700 g/mol (30 OHV) to about 4500 g/mol (25 OHV). One example of a preferred PDG polyol of the presently described technology has an average molecular weight of about 3870 and an OHV of about 28 to about 30. Another example of a PDG polyol has an average molecular weight of 3900 and OHV of 28.7.

The formulation for making the PDG polyols is partially dependent on the hydroxyl values of the corresponding polyols or mixtures of polyols. Typically, when a glycol or a mixture of glycols is used, the PDG polyol can be prepared from a reaction mixture including (a) from about 0.2% to about 70% by weight of a phthalic anhydride or ortho-phthalic acid or a combination thereof; (b) from about 0.1% to about 78% by weight of an aliphatic dicarboxylic acid (e.g., DDDA), a derivative thereof or a combination thereof; and (c) from about 20% to about 87% by weight of at least one polyol (e.g., glycol), all based on the total weight of the three components (a), (b) and (c). Preferably, the reaction mixture can include (a) from about 22% to about 35% by weight, more preferably from about 26% to about 30% by weight, of phthalic anhydride or ortho-phthalic acid or a combination thereof; (b) from about 22% to about 38% by weight, more preferably from about 26% to about 34% by weight, of the aliphatic dicarboxylic acid, a derivative thereof or a combination thereof; and (c) from about 33% to about 47% by weight, more preferably from about 37% to about 43% by weight, of at least one polyol, based on the total weight of the three components (a), (b) and (c).

For example, the polyester polyol of the presently described technology can be prepared using (a) about 30 weight percent of phthalic anhydride; (b) about 30 weight percent of a diacid; (c) about 40 weight percent of glycol; and (d) about 25 ppm of a catalyst, all based on the total weight of the three components (a), (b) and (c). In accordance with one embodiment of the presently described technology, DDDA can be used as the diacid and 1,6-hexanediol as the glycol to make the PDG polyol (i.e., PA-DDDA-1,6-hexanediol polyol in this case). Weight ratios of monomers used are shown in Table 1 below.

TABLE 1
General Weight Percentages For Preparing
PA-DDDA-1,6-HDO Polyols

| | Weight | Example Weight |
|---|---|---|
| Monomer | Percentage Range | Percentage |
| Phthalic Anhydride | about 0.2 to about 56 | 29.9 |
| Dodecanedioic Acid | about 0.1 to about 66 | 29.9 |
| 1,6-Hexanediol | about 33 to about 45 | 40.2 |
| Hydrated Monobutyltin | about 25 to about | 25 ppm |
| Oxide (FASCAT ® 9100) | 500 ppm | |

The PA-DDDA-1,6-Hexanediol polyol can be prepared by reacting the materials in a 3 liter (L), 5 neck flask equipped with an overhead stirrer, condensing arm, nitrogen sparge line, temperature probe, heating mantle and collection flask. The materials can be heated to 225° C. under a nitrogen sparge. When the acid value reaches approximately 2.8 mg KOH/g, vacuum can be applied at 25 inches Hg to the vessel until the acid value reaches approximately 1.8 mg KOH/g. The final hydroxyl value can be 28.7 mg KOH/g. The polyester polyol obtained can be used to make a polyurethane adhesive, such as the PUR hot-melt adhesive described below.

In accordance with a further embodiment of the presently described technology, the reaction mixture for preparing the polyester polyol also includes a hydrophobic material. Generally, the hydrophobic material contains:
(1) from about one to about six radicals, where the radicals being selected are from a group consisting of carboxylic acid groups, carboxylic acid ester groups, hydroxyl groups, and mixtures thereof;
(2) hydrocarbon groups totaling at least about 4 carbon atoms for each radical present; and
(3) an average molecular weight of from about 100 to about 1000.

Preferred hydrophobic materials comprise castor oil, coconut oil, corn oil, cottonseed oil, linseed oil, olive oil, palm oil, palm kernel oil, peanut oil, soybean oil, sunflower oil, tall oil, tallow, a dimer acid thereof, a derivative thereof, or a mixture thereof.

It is to be understood, however, that the hydrophobic materials can be blended in the PDG polyol of the presently described technology to form a mixture; instead of being reacted with the PDG polyol.

### III. POLYURETHANE ADHESIVES

Polyurethane adhesive compositions, such as PUR hot-melt adhesives, can be prepared by reacting an excess of an isocyanate with a polyol or a mixture of polyols. A polyurethane adhesive composition of the presently described technology typically has an unreacted isocyanate value of from about 0.5% to about 20%, and can be made from (I) a reaction mixture comprising from about 15% to about 99% by weight, based on the total weight of the two components (I) and (II), of a PDG polyol of the presently described technology; and (II) at least one aliphatic or aromatic diisocyanate in an amount sufficient to produce the polyurethane adhesive composition having the unreacted isocyanate value of from about 0.5% to about 20%.

1. Isocyanate

Isocyanates useful in the present invention include, among others, polyisocyanates. Aliphatic, cycloaliphatic, araliphatic, aromatic and heterocyclic polyisocyanates are described, for example, by W. Siefken in Justus Liebigs Annalen der Chemie 562: 75-136. Examples of isocyanates include, but are not limited to ethylene diisocyanate, tetramethylene-1,4-diisocyanate, hexamethylene-1,6-diisocyanate, dodecane-1,12-diisocyanate, cyclobutane-1,3-diisocyanate, cyclohexane-1,3- and 1,4-diisocyanate, 1-isocyanato-3,3,5-trimethyl-5-isocyanatomethylcyclohexane (as in German Auslegeschrift No. 1,202,785, U.S. Pat. No. 3,401,190), hexahydrotolylene-2,4- and 2,6-diisocyanate, hexahydrophenylene-1,3- and -1,4-diisocyanate, perhydrodiphenylmethane-2,4′- and 4,4′-diisocyanate, phenylene-1,3- and -1,4-diisocyanate, tolulene-2,4- and -2,6-diisocyanate, diphenylmethane-2,4′- and -4,4′-diisocyanate, naphthylene-1,5-diisocyanate, triphenyl methane-4,4′,4″-triisocyanate, and mixtures thereof.

Other examples include, for example, polyphenyl-polymethylene polyisocyanate which may be obtained by aniline/formaldehyde condensation followed by phosgenation as have been described, for example, in British Pat. Nos. 874,430 and 848,671; m-and p-isocyanatophenyl sulphonyl isocyanate as described according to U.S. Pat. No. 3,454,606; perchlorinated aryl polyisocyanate as described, for example, in U.S. Pat. No. 3,277,138; polyisocyanate containing carbodiimide groups as described in U.S. Pat. No. 3,152,162; the diisocyanates described in U.S. Pat. No. 3,492,330; polyisocyanates containing allophanate groups as described, for example, in British Pat. No. 994,890, Belgian Pat. No. 761, 626 and Published Dutch Pat. Application No. 7,102,524; polyisocyanates containing isocyanurate groups as described, for example, in U.S. Pat. No. 3,001,973, in German Pat. Nos. 1,022,789, 1,222,067 and 1,027,394 and in German Offenlegungsschriften Nos. 1,929,034 and 2,004,048; polyisocyanates containing urethane groups as described, for example, in Belgian Pat. No. 752,261 or in U.S. Pat. No. 3,394,164; polyisocyanates containing acrylated urea groups as described according to German Pat. No. 1,230,778; polyisocyanates containing biuret groups as described, for example, in U.S. Pat. No. 3,124,605, in U.S. Pat. No. 3,201,372 and in British Pat. No. 889,050; polyisocyanates prepared by telomerization reactions as described, for example, in U.S. Pat. No. 3,654,016; polyisocyanates containing ester groups as mentioned, for example, in British Pat. Nos. 965,474 and 1,072,956, in U.S. Pat. No. 3,567,763 and in German Pat. No. 1,231,688; reaction products of the above-mentioned isocyanates with acetals according to German Pat. No. 1,072,385; polyisocyanates containing polymeric fatty acid groups as described in U.S. Pat. No. 3,455,883; and mixtures thereof.

All documents, e.g., patents and journal articles, cited above or below are hereby incorporated by reference in their entirety.

The distillation residues obtained from the commercial production of isocyanates and which still contain isocyanate groups may also be used, optionally dissolved in one or more of the above-mentioned polyisocyanates.

Other suitable polyisocyanates which are readily available include, for example, toluene-2,4- and -2,6-diisocyanate and mixtures of these isomers (“TDI”); polyphenyl polymethylene polyisocyanates which may be obtained by aniline/formaldehyde condensation followed by phosgenation (“crude MDI”); polyisocyanates containing carbodiimide groups, urethane groups, allophanate groups, isocyanurate groups, urea groups or biuret groups (“modified polyisocyanates”); and mixtures thereof.

Suitable polyisocyanurates useful in the present invention can also include, as is well known to those skilled in the art, the cyclotrimerization product of any of the aforementioned polyisocyanates.

Somewhat preferred polyisocyanates are 2,4- and/or 2,4/2,6-toluene diisocyanate, diphenyl methane 4,4′-diisocyanate, hexamethylene diisocyanate, isophorone diisocyanate, and mixtures thereof.

2. Polyurethane Adhesive Synthesis

Synthesis of a polyurethane adhesive, such as a PUR hot-melt adhesive, using the PDG polyols of the presently described technology is relatively straightforward, as representatively shown below in Scheme II. The PDG polyol (e.g., a PA-DDDA polyol) can be used by itself or in combination with other PDG polyols or secondary polyester polyols to make the polyurethane adhesive composition. An example of a suitable secondary polyester polyol is a 1,6-hexanediol-adipate polyol (sometimes referred to as “1,6-HDA” in this disclosure) with a molecular weight of approximately 3740 g/mol (i.e., approximate hydroxyl value of 30), which is one of the polyols most commonly used in PUR hot-melt adhesives. This 1,6-HDA polyol is crystalline in nature and has a melting point at approximately 50° C. Optional additional secondary polyols, such as STEPANPOL® PD-56 (a polyester polyol made from phthalic anhydride and diethylene glycol with a nominal molecular weight of 2000 g/mol, commercially available from Stepan Company, Northfield, Ill.), may be used as shown in Scheme II. More detailed information of secondary polyester polyols that can be used in the presently described technology will be discussed below.

The isocyanate may be 4,4′-methylenebis(phenyl isocyanate) (“MDI”), or other suitable isocyanate as discussed above. Various isocyanates (aromatic or aliphatic) or mixtures of isocyanates can be used to make the polyurethane adhesive. In general, excess isocyanate is added in an amount sufficient to make a prepolymer (i.e., a polyurethane adhesive composition) that has an unreacted isocyanate (—NCO) weight percent value of from about 0.5% to about 20%, preferably from about 0.8% to 5%, more preferably from about 1.0% to about 3%, most preferably from about 1.8% to about 2.5%, based on the ASTM D 2572 method to measure the unreacted isocyanate (—NCO) weight percent value.

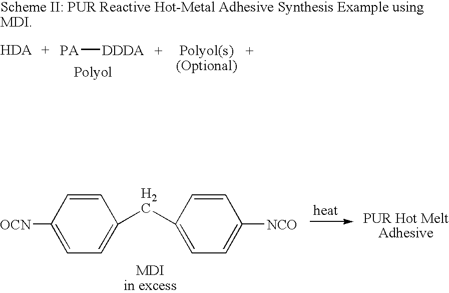

For example, a PUR hot-melt adhesive can be prepared using about 22 weight percent of PDG polyol, about 43 weight percent of HDA, about 22 weight percent of another optional secondary polyol and about 13 weight percent of isocyanate, all based on the weight of the PUR holt melt adhesive product. Preferably, the PDG polyol is a PA-DDDA type polyol. Also preferably, HDA is included as a secondary polyol, along with STEPANPOL® PD-56. The preferred isocyanate is MDI.

In accordance with one embodiment of the presently described technology, a typical PUR hot-melt adhesive composition incorporating a PDG polyol, such as the PA-DDDA-1,6-hexanediol polyol described above, can be made from a reaction mixture comprising, based on the total weight of the following four components:

a) PA-DDDA-1,6-hexanediol based polyol, preferably from about 5% to about 40% by weight, more preferably from about 10% to about 30% by weight, and most preferably from about 15% to about 25% by weight;

b) STEPANPOL® PD-56, a polyester polyol that is made from phthalic anhydride and diethylene glycol with nominal molecular weight of 2000 g/mol (“PD-56”), preferably from about 5% to about 50% by weight, more preferably from about 10% to about 30% by weight, and most preferably from about 15% to about 25% by weight;

c) HDA, preferably from about 25% to about 80% by weight, more preferably from about 30% to about 55% by weight, and most preferably from about 40% to about 45% by weight;

d) MDI, preferably from about 2% to about 25% by weight, more preferably from about 5% to about 20% by weight, and most preferably from about 10% to about 15% by weight.

The composition of a non-limiting example of PUR hot-melt adhesive of this type is shown below in Table 2.

TABLE 2
Formulation Example for
PUR Hot-melt Adhesive Using PA-DDDA Polyol

| | | Weight |
|---|---|---|
| | Hydroxyl Value | Percentage |
| Material* | (mg KOH/g) | (%) |
| PA-DDDA-1,6-HDO Based Polyol | 28.7 | 21.8 |
| STEPANPOL ® PD-56 | 54.2 | 21.8 |
| HDA | 31 | 43.5 |
| MDI | N/A | 12.9 |

*PA: Phthalic Anhydride; DDDA: dodecanedioic acid; 1,6-HDO: 1,6-hexanediol; HDA: 1,6-hexandiol adipate polyol-30 hydroxyl; MDI: 4,4′-methylenebis(phenyl isocyanate).

The synthesis of the adhesive can be as follows. The PA-DDDA-1,6-hexanediol based polyol, HDA, and PD-56 can first be added to a 1 quart container and heated under a nitrogen pad. When the temperature reaches 120° C., MDI can be added and the mixture stirred for 1 hour at 120° C. under nitrogen pad. The mixture can be padded with nitrogen and allowed to stand for about 12 hours at about 25° C. Characterization and evaluation of the adhesive can then be performed on the material as discussed below in the examples.

Other additives such as tackifiers, UV stabilizers, urethane catalysts, and other optional ingredients as discussed in more detail below, can be incorporated to the PUR hot-melt adhesive composition to improve its bonding properties.

### IV. ADDITIONAL COMPONENTS FOR POLYURETHANE ADHESIVES

1. Secondary Polyester Polyol

As disclosed above, secondary polyester polyols can be added to make the polyurethane adhesive compositions of the presently described technology that incorporate the PDG polyols.

For example, the reaction mixtures that generate the moisture-curable polyurethane hot-melt adhesive compositions can contain from about 25 to about 60%, preferably from about 35 to about 50%, by weight of a polyol formed by reacting an α,ω-alkane diol with an α,ω-dioic acid. Generally, any straight or branched chain alkane diol having from about 3 to about 12 carbon atoms can be used to make the polyol. Preferably, the alkane diol comprises a backbone that is a straight chain of from about 4 to about 8 carbon atoms with the two hydroxy groups positioned at the termini of the backbone. More preferably, the backbone is a straight chain consisting of from about 4 to about 7 carbon atoms. Particularly preferred diols include 1,4-butanediol, 1,5-pentanediol, 1,6-hexanediol, and 1,7-heptanediol. Generally, any dicarboxylic (dioic) acid having from about 3 to about 12 carbon atoms can be exploited with regard to the presently described technology. Preferably, the dioic acid comprises a backbone that is a straight chain of from about 3 to about 9 carbon atoms with the two carboxy groups being part of the chain and positioned at the termini of the backbone. More preferably, the backbone is a straight chain consisting of from about 4 to about 8 carbon atoms. Particularly preferred dioic acids are succinic acid, glutaric acid, adipic acid, and pimelic acid. Examples of reaction products of the dioic acid and diol are pentanediolsuccinate (“PDS”), butanediolpimelate (“BDP”), and hexanedioladipate (“HDA”).

Other secondary polyester polyols suitable for use in the polyurethane adhesive compositions of the presently described technology include, for example, phthalic acid diethylene glycol polyester polyols. Suitable secondary phthalic acid diethylene glycol polyester polyols are commercially available from Stepan Company, Northfield, Ill. Representative secondary polyols include, but are not limited to, STEPANPOL® PD-56 (a phthalic anhydride diethylene glycol polyester polyol having an OHV of 56 and a functionality of 2), STEPANPOL® PS-20-200A (a phthalic anhydride diethylene glycol polyester polyol having an OHV of 195 and a functionality of 2), and STEPANPOL® PD-56 LV (a phthalic anhydride diethylene glycol polyester polyol having an OHV of 56 and a functionality of 2), and mixtures thereof.

Still other secondary polyester polyols that are non-phthalic acid-based polyester polyols include, for example, polyester polyols derived from the condensation of caprolactone or adipic acid and a polyalcohol, or other aromatic polyester polyols derived from terephthalic acid, isophthalic acid, or derivatives thereof Specific secondary polyether polyols suitable for use in the methods and compositions of the presently described technology include, for example, the condensation products of propylene glycol/propylene-oxide, trimethylolpropane/ethylene oxide/propylene oxide, trimethylolpropane/propylene oxide, sucrose/propylene glycol/propylene oxide, alkylamine/propylene oxide, and glycerin/propylene oxide, and mixtures thereof.

The polyurethane adhesive compositions of the presently described technology can comprise 1,6-hexanediol adipate (“HDA”) or an orthophthalate diethylene glycol (“OPDEG”) based polyester polyol. Preferred PUR hot-melt adhesive compositions can comprise from about 25% to about 60% by weight of 1,6-hexanediol adipate, more preferably from about 35% to about 50%, and most preferably from about 40% to about 45%, all based on the total weight of the composition. Other preferred PUR compositions can comprise, by weight of the composition, from about 5% to about 40%, more preferably about 10% to about 30%, and most preferably about 15% to about 25% of an OPDEG based polyester polyol. Still other preferred compositions can contain mixtures of HDA and OPDEG polyols.

2. Other Optional Components

The polyurethane adhesive compositions, especially the PUR hot-melt adhesive compositions, described herein may optionally contain a crystalline or high molecular weight (>5000 g/mol) polymer component to improve green strength, a flexible polyol component to improve low temperature adhesion, an amorphous polyester polyol component to improve bonding to polar substrates, and/or an epoxy resin to improve adhesion to steel, aluminum, polyethylene, or polypropylene.

A suitable amount of urethane catalyst may also be added to the polyurethane adhesive composition of the presently described technology. A wide variety of urethane catalysts, such as those described in U.S. Pat. No. 6,569,352, are suitable for use. Generally, any urethane catalyst capable of effecting a polymerization to form a urethane polymer may be used in the presently described technology. Examples of suitable urethane catalysts include, among others, tetramethylbutanediamine (“TMBDA”), 1,4-diaza(2,2,2)bicyclooctane (“DABCO”), dibutyltindilaurate (“DBTDL”) and tinoctoate (“SnOct”), and mixtures thereof.

Other additives such as tackifiers, UV stabilizers and reaction control additives, can be incorporated to these formulations to improve bonding properties. Suitable additives also include phosphorous and benzoyl chloride compounds capable of rendering the PDG polyol suitable for making the polyurethane prepolymer.

In the following examples, all amounts are stated in percent by weight of active material unless indicated otherwise. One skilled in the art will recognize that modifications may be made in the presently described embodiments without deviating from the spirit or scope of the present technology. The presently described technology is illustrated further by the following examples which are not to be construed as limiting the present technology or scope of the specific procedures or compositions described herein. All levels and ranges, temperatures, results etc., used herein are approximations unless otherwise specified. All viscosity data is reported in centipoises (cPs), unless otherwise indicated.

### V. EXAMPLES

1. Preparation of PA-DDDA-1,6-Hexanediol Polyol (“Polyol A”)

In a 3 liter, 5 neck flask equipped with a nitrogen sparge tube, thermocouple, overhead stirrer and distillation arm were charged approximately 329 g of phthalic anhydride, approximately 329 g of dodecanedioic acid, approximately 0.03 g of FASCAT® 9100, and approximately 443 g of 1,6-hexanediol. The mixture was heated to 225° C. under a nitrogen blanket. When the acid value reached approximately 3 the temperature was increased to 230° C. Once the acid value reached a value of less than 2, the reaction was cooled. The polyol had an acid value of 1.87 mg KOH/g, hydroxyl value of 28.7 mg KOH/g and water content of 0.04%. This PDG polyol is designated as “Polyol A.”

2. Polyurethane Reactive Hot-Melt Adhesive Synthesis Using Polyol A

In a quart can, approximately 87 g of Polyol A from Example 1, approximately 87 g of STEPANPOL® PD-56, and approximately 174.1 g of HDA which is available, for example, from Inolex Chemical Company (Philadelphia, Pa.) commercially under the trade name LEXOREZ® 1130-30P was charged. The mixture was then heated to 120° C. under a nitrogen blanket. Once the temperature reached 120° C., approximately 51.9 g of 4,4′-methylenebis(phenyl isocyanate) (MDI) was added and the mixture was stirred at 120° C. for 1 hour. MDI is available, for example, from Bayer Corporation (Pittsburgh, Pa.) commercially under the trade name MONDUR® M. The mixture was padded with nitrogen and allowed to stand for about 12 hours at about 25° C. The prepolymer, i.e., the PUR hot-melt adhesive, was then heated to 120° C. for characterization and testing. Table 3 describes the sample composition.

TABLE 3
Polyurethane Reactive Hot-melt Adhesive Sample Composition

| | | | | Hydroxyl |
|---|---|---|---|---|
| Material | Description | Source | Amount (g) | Value |
| LEXOREZ ® | 1,6-HDO-AA | Inolex | 174.1 | 31 |
| 1130-30P | (HDA) | | | |
| Polyol A | PA-DDDA-1,6- | Stepan | 87 | 28.7 |
| | HDO | | | |
| STEPANPOL ® | PA-DEG | Stepan | 87 | 54.2 |
| PD-56 | | | | |
| MONDUR ® M | MDI (Isocyanate) | Bayer | 51.9 | N.A. |

To test green strength, a test adhesive was applied to one face of a 1″ cube of spruce-pine-fir (SPF) wood; the visible excess was wiped off with a tongue depressor. The coated side of the cube was then applied to a second cube, and a weight of 295 g was applied for 20 seconds. Hooks were then affixed to opposite ends of the assembly. The force necessary for separation of the blocks (applied perpendicular to the joint at separation rate of 5 inches/minute) was recorded. The blocks were pulled at one, three, and six minutes after the time the adhesive was applied.

To determine creep resistance, a Byrd-style applicator was used to draw down a 0.1″ film of adhesive on to a piece of lauan board. Immediately, a two inch overlap of a 4″×1″ piece of lauan was contacted to the treated lauan and pressed momentarily with a hand clamp; three overlaps were prepared this way. The entire assembly was then inverted and suspended from a tabletop with the three test strips of lauan on the lower side. A 50 g weight was instantly suspended from the far (unbonded) end of the lauan strip (Scheme 3). This was also repeated quickly for the two remaining strips using 100 g, and 200 g weights, respectively. The maximum weight held for 1 minute after application was recorded.

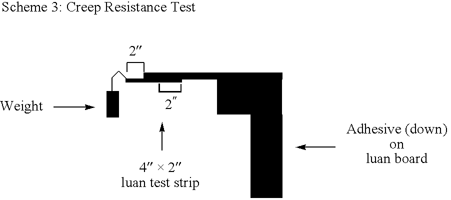

The formulation produced a PUR hot-melt adhesive with the properties shown in Table 4.

TABLE 4
HDA/PA-DDDA-1,6-HDO Polyol/PD-56
PUR Hot-melt Adhesive Characterization

| Property | Value |
|---|---|
| % NCO¹ | 2.13% |
| Viscosity at 120° C.² | 10,480 cPs |
| Open Time³ | 1-1.5 minutes |
| Green Strength | 19.6 psi (1 minute) |
| | 53.8 psi (3 minutes) |
| | 110.3 psi (6 minutes) |
| Creep Resistance | 200 g (Initial) |
| | 1000 g (3 minutes) |

¹ASTM D 2572
²A Brookfield Thermosel Viscometer using a #31 spindle was used.
³ASTM D 4497: For open time measurement, a .01″ thickness pull down bar was used to apply a thin film on a piece of lauan board.

The results show that the PUR hot-melt adhesive had improved green strength and creep resistance property.

To evaluate the HDA/PA-DDDA-1,6-hexanediol Polyol/PD-56 adhesive's abilities to adhere to different substrates, a “quick stick” test was used. In this test, tongue depressors were coated with a thin layer of adhesive (in the same manner as in the green strength test) and applied to various substrates. The adhesives were allowed to cure for three days at room temperature. After curing, an attempt to remove the tongue depressor was completed by hand. The quick stick tests were graded according to the following:
Substrate Failure (S): Tongue depressor or other substrate fractured or tore (most desirable);
Cohesive Failure (C): Adhesive remained on both substrate and tongue depressor;
Adhesive Failure (A): Adhesive remained on one substrate.

Adhesion to stainless steel (SS), polyvinyl chloride (PVC), Lustran® ABS LGM (ABS: acrylonitrile-butadiene-styrene, available from Bayer Plastics, Leverkusen, Germany), fiberglass reinforced plastic (FRP), and expanded polystyrene (EPS) were evaluated. Table 5 below tabulates the results.

TABLE 5
Quick Stick Adhesive Results For
HDA/PA-DDDA-1,6-HDO Polyol/PD-56 PUR Hot-Melt Adhesive

| Substrate | Result |
|---|---|
| SS | S |
| PVC | S |
| Lustran ® ABS LGM | S |
| FRP | S |
| EPS | S |

The results show that the HDA/PA-DDDA-1,6-hexanediol Polyol/PD-56 adhesive bond well to all the substrates tested.

3. Synthesis of PA-DDDA-1,6-HDO Polyol (“Polyol B”)

The following were charged into a 5 liter, four neck flask equipped with a distillation head, stirrer, thermal couple and nitrogen sparge tube: phthalic anhydride (1284 g), DDDA (1284 g), 1,6-hexanediol (1731 g) and FASCAT® 9100 (0.11 g). The flask was heated to 200° C. under nitrogen sparge for approximately 3 hours and then heated to 225° C. When the acid value reached approximately 13 mg KOH/g, another 0.11 g of FASCAT® 9100 was added. When the acid value reached approximately 6.8 mg KOH/g, another 0.22 g of FASCAT® 9100 was added and vacuum applied at 20 inches of Hg. When the acid value reached approximately 4.2, the vacuum was increased to 25 inches Hg and the reaction was stopped at an acid value of 2.9 mg KOH/g. The polyol was cooled to 120° C. and 100 ppm (0.35 g) of 85% phosphoric acid (based on the weight of polyol in the flask) was added. The mixture was stirred under nitrogen sparge for 2 hours and then poured into a 1 gallon container. This PDG polyol is designated herein as “Polyol B,” and its final characteristic properties are shown in Table 6.

4. Synthesis of PA-DDDA-NPG Polyol (“Polyol C”)

The following were charged into a 3 liter, four neck flask equipped with a distillation head, stirrer, thermal couple and nitrogen sparge tube: phthalic anhydride (597 g), DDDA (597 g), neopentyl glycol (709 g) and FASCAT® 9100 (0.14 g). The flask was heated to 200° C. under nitrogen sparge for approximately 8 hours and then heated to 205° C. When the acid value reached approximately 55 mg KOH/g, 0.09 g of FASCAT® 9100 was added. When the acid value reached approximately 44 mg KOH/g, the temperature was increased to 215° C. When the acid value reached approximately 27, another 0.24 g of FASCAT® 9100 was added. When the acid value reached approximately 10, the temperature was increased to 220° C. and then increased to 225° C. When the acid value reached 6.3, the reaction was cooled to 200° C. and 36 g of CARDURA® E-10 was added. The reaction was stirred at this temperature for 5 hours. The polyol was cooled to 145° C. and 100 ppm (0.18 g) of 85% phosphoric acid (based on the weight of polyol in the flask) was added. The mixture was stirred under nitrogen sparge for 1 hour and then poured into two 1 quart containers. This PDG polyol was designated herein as “Polyol C,” and its final characteristic properties are shown below in Table 6.

5. Synthesis of PA-DDDA-DEG Polyol (Polyol D)

The following were charged into a 3 liter, four neck flask equipped with a distillation head, stirrer, thermal couple and nitrogen sparge tube: Phthalic anhydride (779 g), DDDA (779 g), diethylene glycol (941 g) and FASCAT® 9100 (0.19 g). The flask was initially heated to 180° C. under nitrogen sparge for approximately 2 hours and then heated to 200° C. When the acid value reached approximately 35 mg KOH/g, 0.19 g of FASCAT® 9100 was added and the temperature increased to 215° C. Vacuum was then applied at 5 inches Hg and slowly increased during the reaction to a maximum of 20 inches Hg. When the acid value reached approximately 5 mg KOH/g, the temperature was increased to 230° C. When the acid value reached approximately 3.5, the polyol was cooled to 200° C. and 31.3 g of CARDURA® E-10 was added. The reaction was stirred at 200° C. for 5 hours. The polyol was cooled to 120° C. and 70 ppm (0.16 g) of 85% phosphoric acid (based on the weight of polyol in the flask) was added. The mixture was stirred under nitrogen sparge for 1 hour and then poured into two 1 quart containers. This PDG polyol is designated as “Polyol D,” and its final characteristic properties are shown below in Table 6.

TABLE 6
Polyol Characterization

| | | Corrected | | | |
|---|---|---|---|---|---|
| | | OHV | Acid Value | Viscosity | % |
| Product | Composition | (mg KOH/g) | (mg KOH/g) | (cPs) | Moisture |
| Polyol B | PA, DDDA, HDO | 35 | 3.0 | @ 70° C. | 0.04 |
| | | | | 56,200 | |
| Polyol C | PA, DDDA, NPG, | 48.3 | 0.32. | @ 100° C.: | 0.02 |
| | CARDURA ® E-10 | | | 55,600 | |
| Polyol D | PA, DDDA, DEG, | 27 | 0.36 | @ 70° C.: | 0.01 |
| | CARDURA ® E-10 | | | 10,400 | |

6. Polyurethane Reactive Hot-melt Evaluation Of Polyols B. C, and D

Polyols B, C, and D were evaluated in PUR hot-melt adhesive formulations. Five PUR hot-melt adhesives were prepared in the same manner as discussed in Example 2. Characterization of these formulations were done and are listed in Table 7. The results show that four of the formulations produced clear formulations at 120° C. while the formulation incorporating PD-56 gave an opaque formulation at 120° C. The viscosity stabilities of these formulations were monitored at 120° C. for approximately four hours. The results show that formulation 1 increased in viscosity 5.8%/hour, while other four formulations all increased in viscosity less than 4.5%/hour.

TABLE 7
Characterization Of PUR Hot-melt Adhesives Using PA-DDDA Polyols

| | Polyol | | | |
|---|---|---|---|---|
| | Composition/ | | | |
| | Weight | | Viscosity @ | Appearance @ |
| Formulation | Ratio | % NCO | 120° C. | 120° C. |
| 1 | Polyol B only | 2.94 | 9300 | Clear |
| 2 | HDA/Polyol B/ | 2.13 | 10,480 | Opaque |
| | PD-56 (50/25/25) | | | |
| 3 | HDA/Polyol C | 2.98 | 7020 | Clear |
| | (50/50) | | | |
| 4 | HDA/Polyol D | 2.12 | 5820 | Clear |
| | (50/50) | | | |
| 5 | HDA/Polyol B | 2.69 | 6300 | Clear |
| | (50/50) | | | |

The green strength, creep and open times were measured for each formulation in the same manner as discussed in Example 2. Table 8 summarizes these results.

TABLE 8
Green Strength, Creep Resistance And Open Time Of
PA-DDDA PUR Hot Melt Adhesives

| | Green Strength (psi) | | | Creep * (g) | | Open Time |
|---|---|---|---|---|---|---|
| Formulation | 1 min. | 3 min. | 6 min. | Initial | 3 min. | (min) |
| 1 | 6.8 | 5.8 | 5.9 | 50 | 50 | >10 |
| 2 | 19.6 | 53.8 | 110.3 | 200 | 1000 | 1.5 |
| 3 | 3.8 | 57.9 | 93.9 | 50 | 1000 | 2 |
| 4 | 4.2 | 24.9 | 24.5 | 300 | 1000 | 0.5 |
| 5 | 1.7 | 21.7 | 20.6 | 50 | 1000 | 1.5 |

Comparing formulations 2 (with PD-56) and 5 (with no PD-56) shows that the addition of PD-56 improves both the green strength and creep. Although not wanting to be bound by any theory, this is presumably due to PD-56 forcing recrystallization of the HDO backbone in the reactive hot-melt system having PD-56. Moreover, the addition of PD-56 did not affect the open time of the HDA/Polyol B formulation 5. The DEG based formulation 4 also showed good creep., while the NPG formulation 3 showed both good creep and green strength.

Formulations 1, 2, and 5, which all incorporated Polyol B were used to bond various substrates to wood. Table 9 summarizes the results below. Designations are as follows: S=substrate failure (wood breakage, most desirable); C=cohesive failure (adhesive remains on both substrate and wood); A=adhesive failure (adhesive remains on either the substrate or wood); Al (aluminum); SS (stainless Steel); ABS (acrylonitrile-butadiene-styrene); PVC (polyvinyl chloride), FRP (fiberglass reinforced plastic). All substrates were untreated.

TABLE 5
Bonding profile for adhesive formulations.

| | Polyol | | | | | |
|---|---|---|---|---|---|---|
| | Composition/Weight | | | ABS- | | |
| Formulation | Ratio | Al | SS | Lustran ® | PVC | FRP |
| 1 | Polyol B only | S | S | S | S | S |
| 2 | HDA/Polyol | S | S/C | S | S | S |
| | B/PD-56 | | | | | |
| | (50/25/25) | | | | | |
| 5 | HDA/Polyol B | S | S | S | S | S |
| | (50/50) | | | | | |

The results show that the adhesive made from polyol B (PA-DDDA-1,6-HDO polyol) only bond well to a variety of substrate materials including ABS; the adhesive made from polyol B and HDA (50/50 weight ratio) bond well to all substrate materials tested as well; the adhesive made from 50:25:25 weight ratio of HDA/Polyol B/PD-56 also showed very good bonding profile.

The presently described technology, which includes the PDG polyol and the manner and process of making and using it, are now described in such full, clear, concise and exact terms as to enable any person skilled in the art to which it pertains, to make and use the same. It is to be understood that the foregoing describes preferred embodiments of the presently described technology and that modifications may be made therein without departing from the spirit or scope of the invention as set forth in the claims.

What is claimed is:

1. A polyester polyol prepared from a reaction mixture comprising:
(a) a phthalic acid based material containing more than about 10% by weight, based on the total weight of the phthalic acid based material, of ortho-phthalic acid, a derivative of ortho-phthalic acid or a mixture thereof;
(b) at least one aliphatic dicarboxylic acid or derivative thereof having a straight or branched carbon chain that has four or more carbon atoms; and
(c) at least one polyol; and
wherein the polyester polyol has an average hydroxyl value of from about 5 to about 405.

2. The polyester polyol of claim 1, wherein the phthalic acid based material comprises more than about 10% by weight of phthalic anhydride or ortho-phthalic acid or a mixture thereof, and constitutes from about 0.2% to about 70% by weight of the total weight of components (a), (b), and (c) of claim 1.

3. The polyester polyol of claim 1, wherein the aliphatic dicarboxylic acid or derivative thereof comprises an aliphatic dioic acid or derivative thereof having a straight or branched carbon chain that is from about four to twenty carbon atoms long, and constitutes from about 0.1% to about 78% by weight of the total weight of components (a), (b), and (c) of claim 1.

4. The polyester polyol of claim 1, wherein the at least one polyol constitutes from about 20% to about 87% by weight of the total weight of components (a), (b), and (c); and has the formula:
HO—R₁—OH
wherein R₁ represents:
(1) alkylene groups of from about 2 to about 12 carbon atoms;
(2) —CH₂—R₂—CH₂— where R₂ represents: 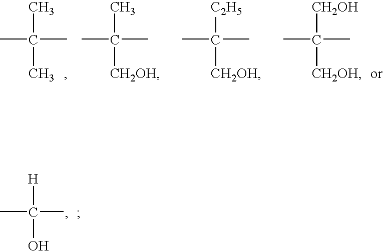
or
(3) —(R₃O)ₙ—R₃— where each R₃ independently represents an alkylene group of from about 2 to about 4 carbon atoms, and n is an integer of from about 1 to about 200.

5. The polyester polyol of claim 1, wherein the reaction mixture further comprises an esterification or transesterification catalyst.

6. The polyester polyol of claim 5, wherein the esterification or transesterification catalyst comprises a tin or titanium catalyst.

7. The polyester polyol of claim 1 having an average hydroxyl value of from about 15 to about 150.

8. The polyester polyol of claim 1 having an average hydroxyl value of from about 20 to about 35.

9. The polyester polyol of claim 1, wherein the aliphatic dicarboxylic acid or derivative thereof comprises dodecanedioic acid, succinic acid, glutaric acid, adipic acid, azelaic acid, sebacic acid, decanedicarboxylic acid, octadecanedicarboxylic acid, 1,4-cyclohexanedicarboxylic acid, dimerized fatty acids, fumaric acid, a derivative thereof, or a mixture thereof.

10. The polyester polyol of claim 1, wherein the polyol comprises 1,6-hexanediol, diethylene glycol, neopentyl glycol, glycerine, trimethyolpropane, pentaerythritol, or a combination thereof.

11. The polyester polyol of claim 1, wherein the reaction mixture comprises:
(a) from about 22% to about 35% by weight of phthalic anhydride, ortho-phthalic acid, or a mixture thereof;
(b) from about 22% to about 38% by weight of dodecanedioic acid, a derivative thereof or a mixture thereof; and
(c) from about 33% to about 47% by weight 1,6-hexanediol, all based on the total weight of components (a), (b), and (c).

12. The polyester polyol of claim 1, wherein the reaction mixture further comprises a hydrophobic material containing:
(1) from about one to about six radicals, where the radicals being selected are from a group consisting of carboxylic acid groups, carboxylic acid ester groups, hydroxyl groups, and mixtures thereof;
(2) hydrocarbon groups totaling at least 4 carbon atoms for each radical present; and
(3) an average molecular weight of from about 100 to about 1000.

13. The polyester polyol of claim 11, wherein the hydrophobic material comprises castor oil, coconut oil, corn oil, cottonseed oil, linseed oil, olive oil, palm oil, palm kernel oil, peanut oil, soybean oil, sunflower oil, tall oil, tallow, a dimer acid thereof, a derivative thereof, or a combination thereof.

14. A polyurethane adhesive composition having an unreacted isocyanate value of from about 0.5% to about 20% obtained from a reaction mixture comprising:
(1) from about 15% to about 99% by weight, based on the total weight of components (I) and (II), of a polyester polyol which is the product of a reaction mixture comprising:
(a) a phthalic acid based material containing more than about 10% by weight, based on the total weight of the phthalic acid based material, of ortho-phthalic acid, a derivative of ortho-phthalic acid or a mixture thereof;
(b) at least one aliphatic dicarboxylic acid or derivative thereof having a straight or branched carbon chain that has four or more carbon atoms; and
(c) at least one polyol; and
wherein the polyester polyol has an average hydroxyl value of from about 5 to about 405; and
(II) at least one aliphatic or aromatic diisocyanate in an amount sufficient to produce the polyurethane adhesive composition having the unreacted isocyanate value of from about 0.5% to about 20%.

15. The polyurethane adhesive composition of claim 14, wherein the polyester polyol is the product of a reaction mixture comprising, based on the total weight of components (a), (b) and (c):
(a) from about 0.2% to about 70% by weight of a phthalic anhydride or ortho-phthalic acid, or a combination thereof;
(b) from about 0.1% to about 78% by weight of at least one aliphatic dioic acid or derivative thereof having a straight or branched carbon chain that is from about four to twenty carbon atoms long; and
(c) from about 20% to about 87% by weight of at least one polyol of the formula:
HO—R₁—OH
wherein R₁ represents:
(1) alkylene groups of from about 2 to about 12 carbon atoms;
(2) —CH₂—R₂—CH₂— where R₂ represents: 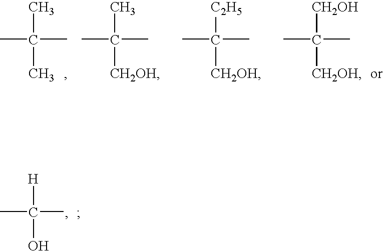
or
(3) —(R₃O)ₙ—R₃— where each R₃ independently represents an alkylene group of from about 2 to about 4 carbon atoms, and n is an integer of from about 1 to about 200.

16. The polyurethane adhesive composition of claim 14 having an unreacted isocyanate value of from about 0.8% to about 5%.

17. The polyurethane adhesive composition of claim 14, wherein the diisocyanate comprises ethylene diisocyanate, tetramethylene-1,4-diisocyanate, hexamethylene-1,6-diisocyanate, dodecane-1,12-diisocyanate, cyclobutane-1,3-diisocyanate, cyclohexane-1,3- or 1,4-diisocyanate, 1-isocyanato-3,3,5-trimethyl-5-isocyanatomethylcyclohexane, hexahydrotolylene-2,4- or 2,6-diisocyanate, hexahydrophenylene-1,3- or -1,4-diisocyanate, perhydrodiphenylmethane-2,4′- or 4,4′-diisocyanate, phenylene-1,3- or -1,4-diisocyanate, tolulene-2,4- or -2,6-diisocyanate, diphenylmethane-2,4′- or -4,4′-diisocyanate, naphthylene-1,5-diisocyanate, triphenyl methane-4,4′,4″-triisocyanate, polyphenyl-polymethylene polyisocyanate, m- or p-isocyanatophenyl sulphonyl isocyanate, perchlorinated aryl polyisocyanate, polyisocyanate containing carbodiimide groups, toluene-2,4- or -2,6-diisocyanate, polyphenyl polymethylene polyisocyanate, a derivative thereof, or a combination thereof.

18. The polyurethane adhesive composition of claim 14, wherein the diisocyanate comprises 2,4- or 2,6-toluene diisocyanate, diphenyl methane 4,4′-diisocyanate, hexamethylene diisocyanate, isophorone diisocyanate, a derivative thereof, or a combination thereof.

19. The polyurethane adhesive composition of claim 14, further comprising a secondary polyester polyol formed by reacting an α,ω-alkanediol with an α,ω-dioic acid.

20. The polyurethane adhesive composition of claim 14, further comprising a secondary polyester polyol which is 1,6-hexanediol adipate, a phthalate-diethylene glycol based polyester polyol, or a combination thereof.

21. The polyurethane adhesive composition of claim 14, further comprising from about 25% to about 80% by weight of 1,6-hexandiol-adipate, based on the total weight of the composition.

22. The polyurethane adhesive composition of claim 14, further comprising from about from about 5% to about 50% by weight of a phthalate-diethylene glycol based polyester polyol, based on the total weight of the composition.

23. The polyurethane adhesive composition of claim 14, wherein the at least one aliphatic dicarboxylic acid comprises dodecanedioic acid or a derivative thereof;
and wherein the at least one polyol comprises 1,6-hexanediol, diethylene glycol, neopentyl glycol, glycerine, pentaerythritol, or a combination thereof.

24. The polyurethane adhesive composition of claim 14, further comprising a urethane catalyst.

25. The polyurethane adhesive composition of claim 24, wherein the urethane catalyst comprises tetramethylbutanediamine, 1,4-diaza(2,2,2)bicyclooctane, dibutyltindilaurate, tinoctoate, dimorpholine diethylether, or a combination thereof.

26. The polyurethane adhesive composition of claim 24, wherein the urethane catalyst constitutes from about 0% to about 5.0% by weight of the total weight of the polyurethane adhesive composition.

27. The polyurethane adhesive composition of claim 14, wherein the polyester polyol has an average hydroxyl value of from about 20 to about 35, and is the product of a reaction mixture comprising:
(a) from about 22% to about 35% by weight phthalic anhydride;
(b) from about 22% to about 38% by weight dodecanedioic acid; and
(c) from about 33% to about 47% by weight 1,6-hexanediol,
all based on the total weight of the three components (a), (b) and (c).

28. A method of bonding a first substrate to a second substrate comprising: applying to at least one of the substrates a polyurethane adhesive composition having an unreacted isocyanate value of from about 0.5% to about 20% obtained from a reaction mixture comprising:
(I) from about 15% to about 99% by weight, based on the total weight of components (I) and (II), of a polyester polyol which is the product of a reaction mixture comprising:
(a) a phthalic acid based material containing more than about 10% by weight, based on the total weight of the phthalic acid based material, of ortho-phthalic acid, a derivative of ortho-phthalic acid or a mixture thereof;
(b) at least one aliphatic dicarboxylic acid or derivative thereof having a straight or branched carbon chain that has four or more carbon atoms; and
(c) at least one polyol; and
wherein the polyester polyol has an average hydroxyl value of from about 5 to about 405; and
(II) at least one aliphatic or aromatic diisocyanate in an amount sufficient to produce the polyurethane adhesive composition having the unreacted isocyanate value of from about 0.5% to about 20%.

29. The method of claim 28, wherein the substrate comprises wood, steel, aluminum, polyvinyl chloride, acrylonitrile-butadiene-styrene, fabric, fiberglass reinforced plastic, or expanded polystyrene.
